(19) United States
(12) Patent Application Publication
(10) Pub. No.: US 2004/0042442 A1
(43) Pub. Date: Mar. 4, 2004

(54) Methods and apparatus for simultaneous independent voice and data services using a remote subscriber identity module (SIM)

(76) Inventors: Mark E. Pecen, Rolling Meadows, IL (US); Niels Peter Skov Andersen, Roskilde (DK); Michael D. Kotzin, Buffalo Grove, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/230,681

(22) Filed: Aug. 29, 2002

(51) Int. Cl. H04L 12/66

(52) U.S. Cl. 370/352; 370/455

(57) ABSTRACT

Methods and apparatus for simultaneous independent voice and data services using a remote subscriber identity module (SIM) are disclosed. The methods and apparatus described herein allow a personal computer (or other data station) which does not contain a SIM card and a mobile phone (or other voice station) which does contain a SIM card to cooperate wirelessly to allow the personal computer to use the SIM card in the mobile phone in a virtual manner. As a result, the personal computer may transmit and receive packet-switched data at the same time the mobile phone is transmitting or receiving a circuit-switched voice signal without interference between the two simultaneous transmissions.

### TECHNICAL FIELD

The present invention relates in general to wireless voice and data communications systems, and in particular, to methods and apparatus for sharing a Subscriber Identity Module (SIM) card between a mobile data station which does not contain the SIM card and a mobile voice station which does contain the SIM card.

### BACKGROUND

The Global System for Mobile Communications (GSM) General Packet Radio Service (GPRS) is intended to allow the service subscriber the ability to send and receive data in an end-to-end packet transfer mode without utilizing network resources in the circuit-switched mode. GPRS permits efficient use of radio and network resources when data transmission characteristics are i) packet based, ii) intermittent and non-periodic, iii) possibly frequent, with small transfers of data, e.g., less than 500 octets, or iv) possibly infrequent, with large transfers of data, e.g., more than several hundred kilobytes. User applications may include Internet browsers, electronic mail, etc.

The European Telecommunications Standards Institute (ETSI) GSM specifications define for GPRS mobile stations, what is referred to as a “mobile station class,” which specifies some of the behavior to which a mobile station must conform regarding its operation in i) packet mode, ii) circuit-switched mode or iii) both. A Class A mobile station supports simultaneous attachment, monitoring, activation, invocation and traffic flow on both i) circuit-switched voice and ii) packet-switched data services. A Class B mobile station supports simultaneous attachment, monitoring and activation on both i) circuit-switched voice and ii) packet-switched data services, with invocation and traffic flow possible on either service on a mutually exclusive basis. A Class C mobile station supports only non-simultaneous attach, i.e., mutually exclusive attach on either i) circuit-switched voice or ii) packet-switched data services.

The problem among operators and manufacturers stems from the fact that providing a Class A capable mobile station would require both two receivers and transmitters, along with a combiner/duplexer, interface to a common Subscriber Identity Module (SIM) card and possibly an additional call processor, depending upon the number of embedded user-level applications desired to coexist during circuit-switched voice and packet-switched data service operation. This presents the need among mobile station manufacturers to develop a possibly new architecture for such equipment at a higher cost device to the operator.

### BRIEF DESCRIPTION OF THE DRAWINGS

Features and advantages of the disclosed methods and apparatus will be apparent to those of ordinary skill in the art in view of the detailed description of example embodiments which is made with reference to the drawings, a brief description of which is provided below.

FIG. 1 is a high level block diagram of a communications system illustrating an environment of use for the disclosed system.

FIG. 2 is a more detailed block diagram of the personal computer illustrated in FIG. 1.

FIG. 3 is a more detailed block diagram of the mobile telephone illustrated in FIG. 1.

FIG. 4 is a more detailed block diagram showing the mobile telephone and the personal computer illustrated in FIG. 1.

FIG. 5 is a flowchart of a process for sharing a Subscriber Identity Module (SIM) card between a mobile data station which does not contain the SIM card and a mobile voice station which does contain the SIM card.

### DETAILED DESCRIPTION OF EXEMPLARY EMBODIMENTS

In general, the methods and apparatus described herein facilitate simultaneous independent voice and data services using a remote subscriber identity module (SIM). The methods and apparatus disclosed allow a personal computer (or other data station) which does not contain a SIM card and a mobile phone (or other voice station) which does contain a SIM card to cooperate wirelessly to allow the personal computer to use the SIM card in the mobile phone in a virtual manner. As a result, the personal computer may transmit and receive packet-switched data at the same time the mobile phone is transmitting or receiving a circuit-switched voice signal without interference between the two simultaneous transmissions.

A high level block diagram of an exemplary network communications system 100 is illustrated in FIG. 1. Typically, the system 100 includes one or more mobile telephones 102, one or more personal computers 104, one or more circuit-switched voice cells 106, and one or more packet-switched data cells 108. Each of the mobile telephones 102 may communicate with each of the circuit-switched voice cells 106 via a wireless connection 110 using a voice communication protocol such as a 2.1 GHz Universal Mobile Telecommunications System (UMTS) protocol. Similarly, each of the personal computers 104 may communicate with each of the packet-switched data cells 108 via another wireless connection 112 using a data communication protocol such as a 900 MHz Global System for Mobile Communication (GSM) protocol. In addition, a mobile telephone 102 and a personal computer 104 located near each other may communicate with each other via yet another wireless connection 114 using another data communication protocol such as a Bluetooth protocol. Using this wireless connection 114 and additional software, as described in detail below, a mobile telephone 102 and a personal computer 104 located near each other may act as a “virtual” Class A GSM device 116 capable of simultaneous voice and data communication.

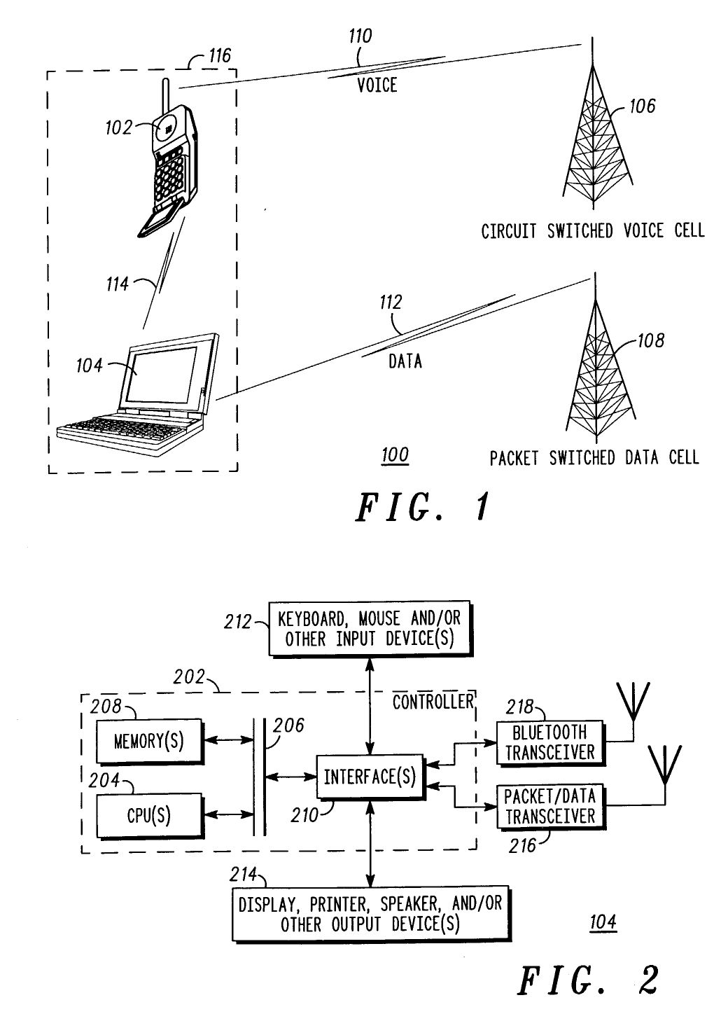

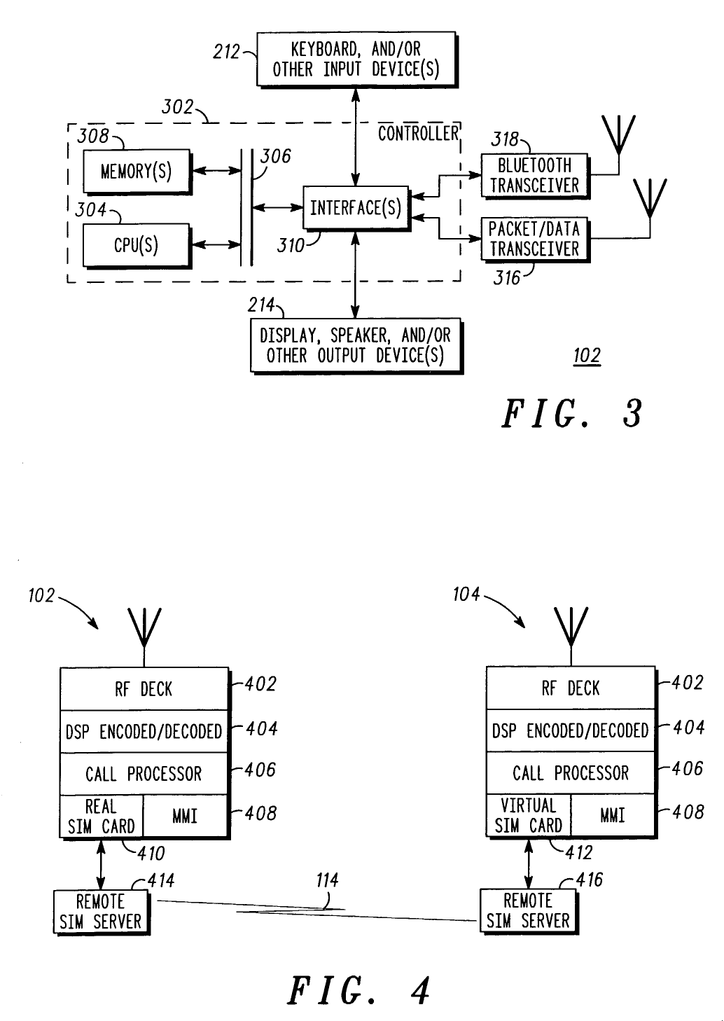

A more detailed block diagram of a personal computer (PC) 104 is illustrated in FIG. 2. The personal computer 104 may be a laptop computer, a desktop computer, a personal digital assistant (PDA), an Internet appliance, or any other communication device. The personal computer 104 includes a controller 202 which preferably includes a central processing unit (CPU) 204 electrically coupled by an address/data bus 206 to a memory device 208 and one or more interface circuits 210. The CPU 204 may be any type of well known CPU, such as a microprocessor from the Intel PentiumTM family of microprocessors, the Intel ItaniumTM family of microprocessors, and/or the Intel XScaleTM family of processors. The memory device 208 preferably includes volatile memory and non-volatile memory. Preferably, the memory device 208 stores a software program that interacts with one or more other devices in the system 100 as described below. This program may be executed by the CPU 204 in a well known manner. The memory device 208 may also store digital data indicative of documents, files, programs, web pages, etc. stored during manufacture of the personal computer 104, retrieved from one or more other devices in the system 100, and/or loaded via an input device 212.

The interface circuit(s) 210 may be implemented using any type of well known interface standard, such as an Ethernet interface and/or a Universal Serial Bus (USB) interface. One or more input devices 212 may be connected to the interface circuit 210 for entering data and commands into the controller 202. For example, the input device 212 may be a keyboard, mouse, touch screen, track pad, track ball, isopoint, and/or a voice recognition system.

One or more displays, printers, speakers, and/or other output devices 214 may also be connected to the controller 202 via the interface circuit 210. The display 214 may be cathode ray tube (CRTs), liquid crystal displays (LCDs), or any other type of display. The display 214 generates visual displays of data generated during operation of the PC 104. The display 214 may be used to display web pages, e-mail, etc. The visual displays may include prompts for human operator input, calculated values, detected data, etc.

Preferably, the PC 104 also includes a packet data transceiver 216. Using the packet data transceiver 216, the PC 104 may exchange data with one or more packet-switched data cells 108 via a wireless connection 112 to the packet-switched data cells 108. The wireless connection may be any type of wireless connection, such as a 900 MHz GSM connection. Users of the system 100 may be required to identify themselves to the system as an authorized user. In such an instance, a Subscriber Identity Module (SIM) card containing a valid access code may be required for the activation of services. However, in the preferred embodiment, the SIM card is not present in the PC 104. The access code may be encrypted prior to transmission across the wireless connection 112.

In addition, the PC 104 preferably includes a short-range data transceiver 218, such as a Bluetooth transceiver. Using the short-range data transceiver 218, the PC 104 may exchange data, such as SIM card data, with a nearby mobile phone 102 via a wireless connection 114 to the mobile phone 102.

A more detailed block diagram of a mobile phone 102 is illustrated in FIG. 3. The mobile phone 102 may be any type of mobile station. The mobile phone 102 includes a controller 302 which preferably includes a central processing unit (CPU) 304 electrically coupled by an address/data bus 306 to a memory device 308 and one or more interface circuits 310. The CPU 304 may be any type of well known CPU. The memory device 308 preferably includes volatile memory and non-volatile memory. Preferably, the memory device 308 stores a software program that interacts with one or more other devices in the system 100 as described below. This program may be executed by the CPU 304 in a well known manner. The memory device 308 may also store digital data indicative of documents, files, programs, web pages, etc. stored during manufacture of the mobile phone 102, retrieved from one or more other devices in the system 100, and/or loaded via an input device 312.

The interface circuit(s) 310 may be implemented using any type of well known interface standard. One or more input devices 312 may be connected to the interface circuit 310 for entering data and commands into the controller 302. For example, the input device 312 may be a keyboard and/or a voice recognition system.

One or more displays, speakers, and/or other output devices 314 may also be connected to the controller 302 via the interface circuit 310. The display 314 may be a light emitting diode (LED) display, a liquid crystal display (LCD), or any other type of display. The display 314 generates visual displays of data generated during operation of the mobile phone 102. The visual displays may include prompts for human operator input, calculated values, detected data, etc.

Preferably, the mobile phone 102 also includes a circuit-switched voice transceiver 316. Using the voice transceiver 316, the mobile phone 102 may exchange voice signals with one or more circuit-switched voice cells 106 via a wireless connection 110 to the circuit-switched voice cells 106. The wireless connection may be any type of wireless connection, such as a 2.1 GHz Universal Mobile Telecommunications System (UMTS) connection. Users of the system 100 may be required to identify themselves to the system as an authorized user. In such an instance, a Subscriber Identity Module (SIM) card containing a valid access code may be required for the activation of services. In the preferred embodiment, the SIM card is present in the mobile phone 102. The access code may be encrypted prior to transmission across the wireless connection 110.

In addition, the mobile phone 102 preferably includes a short-range data transceiver 318, such as a Bluetooth transceiver. Using the short-range data transceiver 318, the mobile phone 102 may exchange data, such as SIM card data, with a nearby PC 104 via a wireless connection 114 to the PC 104.

Another detailed block diagram showing the mobile telephone 102 and the personal computer 104 is illustrated in FIG. 4. Both devices include a radio frequency (RF) deck 402. Each RF deck 402 interfaces an antenna with a digital signal processor (DSP) coder/decoder (codec) 404. For example, each RF deck 402 typically includes a receiver and a transmitter. The DSP codec 404 samples signals received from the RF deck 402 and decodes the received signals for a call processor 406. In addition, the DSP codec 404 encodes signals from the call processor 406 for transmission via the RF deck 402.

Each call processor 406 handles high level control of communications between the mobile station 102, 104 and an associated communication cell 106, 108. In order to control communications and other functions for the mobile station 102, 104, each call processor 406 interfaces to a memory management interface (MMI) 408. In addition, for certain protocols, the call processor 406 must access a Subscriber Identity Module (SIM) card 410. In the example illustrated in FIG. 4, the mobile phone 102 includes the SIM card 410. Accordingly, the mobile phone 102 may access the SIM card 410 in a well known manner.

However, the PC 104 may not include a SIM card 410. Accordingly, the PC 104 access a “virtual” SIM card 412. In order to access the “virtual” SIM card 412, the mobile phone may be equipped with a remote SIM server module 414, and the PC 104 may be equipped with a remote SIM client module 416. In such an arrangement, when the remote SIM client module 416 requests SIM data, the remote SIM server module 414 supplies the requested data. This process is described in U.S. patent Ser. No. 09/648,955 filed Aug. 5, 2000, which is incorporated herein by reference.

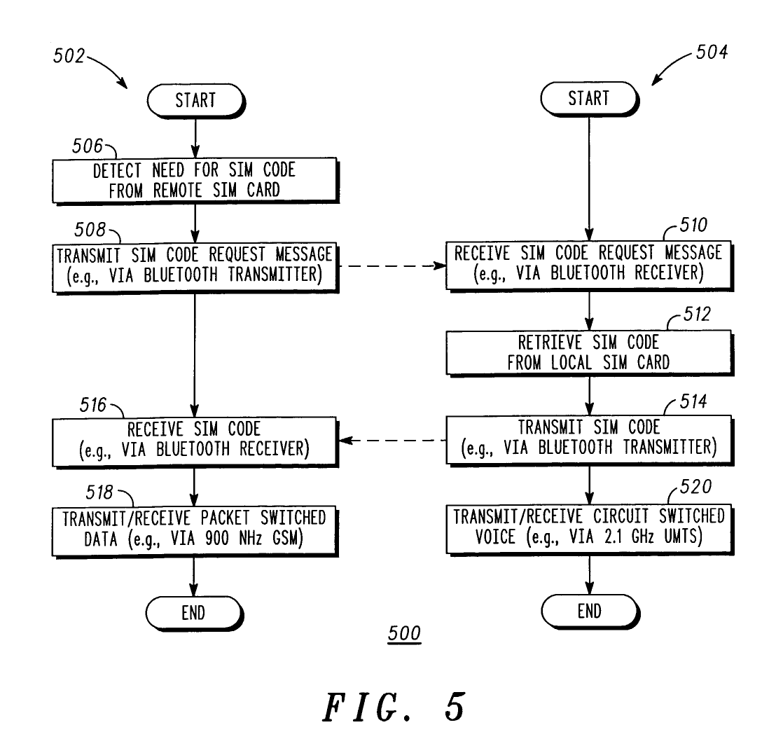

A flowchart of a process 500 for sharing a Subscriber Identity Module (SIM) card 410 between a mobile data station, such as PC 104 which does not contain the SIM card 410, and a mobile voice station, such as mobile telephone 102 which does contain the SIM card 410 is illustrated in FIG. 5. Preferably, the process 500 is embodied in a software program which is stored in the PC memory 208 and/or the mobile phone memory 308 and executed by the PC CPU 204 and/or the mobile phone CPU 304 in a well known manner. However, some or all of the steps of the process 500 may be performed manually and/or by another device. Although the process 500 is described with reference to the flowchart illustrated in FIG. 5, a person of ordinary skill in the art will readily appreciate that many other methods of performing the acts associated with process 500 may be used. For example, the order of many of the steps may be changed. In addition, many of the steps described are optional.

Generally, the process 500 causes a PC 104 which does not contain a SIM card 410 and a mobile phone 102 which does contain a SIM card 410 to cooperate wirelessly to allow the PC 104 to use the SIM card 410 in the mobile phone 102 in a virtual manner. As a result, the PC 104 may transmit and receive packet-switched data at the same time the mobile phone 102 is transmitting or receiving a circuit-switched voice signal without interference.

The process 500 begins when a PC 104 detects a need for a SIM code from a remote SIM card 410 (block 506). For example, a user of the PC 104 may request a web page, send an e-mail message, receive an e-mail message, etc. As a result, the PC 104 may attempt to communicate with a packet-switched data cell 108 via a wireless connection 112 using a data communication protocol which requires a SIM code, such as a GSM protocol. However, if the PC 104 does not contain a SIM card 410, the PC 104 preferably attempts to use a “virtual” SIM card 412.

Accordingly, the PC 104 transmits a SIM code request message via a short-range wireless transmitter, such as a Bluetooth transmitter (block 508). Subsequently, the mobile phone 102 receives the SIM code request message if the mobile phone 102 is within range of the PC 104 (block 510). Preferably, communications between the PC 104 and the mobile phone 102 via the Bluetooth communication channel 114 are private to the PC 104 and the mobile phone 102.

If the mobile phone 102 is in range and receives the SIM code request message, the mobile phone 102 preferably retrieves the SIM code from a local SIM card 410 in a well known manner (block 512). The retrieved SIM code is then transmitted to the PC 104 via the short-range (e.g., Bluetooth) communication channel 114 (block 514). As a result, the PC 104 receives the SIM code wirelessly, without the need for a local SIM card 410 (block 516).

After the PC 104 receives the SIM code from the remote mobile phone 102, the PC 104 and the mobile phone 102 may transmit and/or receive signals under the authority of the SIM code simultaneously without radio interference and without requiring the resources of the other. Specifically, the PC 104 may transmit/receive a packet-switched data signal (block 518), and the mobile phone 102 may transmit/receive a circuit-switched voice signal (block 520). For example, the PC 104 may transmit/receive a 900 MHz GSM packet-switched data signal, and the mobile phone 102 may transmit/receive a 2.1 GHz UMTS circuit-switched voice signal.

In summary, persons of ordinary skill in the art will readily appreciate that methods and apparatus for simultaneous independent voice and data services using a remote subscriber identity module (SIM) have been provided. The foregoing description has been presented for the purposes of illustration and description. It is not intended to be exhaustive or to limit the claimed invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of sharing a Subscriber Identity Module (SIM) card between a mobile data station which does not contain the SIM card and a mobile voice station which does contain the SIM card, the mobile data station being a physically different device than the mobile voice station, the method comprising:
transmitting a SIM request from the mobile data station to the mobile voice station;
retrieving a SIM code from the SIM card in response to receiving the SIM request; and
transmitting the SIM code from the mobile voice station to the mobile data station.

2. A method as defined in claim 1, further comprising:
transmitting voice information from the mobile voice station under the authority of the SIM code; and
transmitting data from the mobile data station under the authority of the SIM code, the data being transmitted simultaneous with the voice information.

3. A method as defined in claim 2, wherein transmitting voice information from the mobile voice station comprises transmitting circuit-switched voice information from the mobile voice station.

4. A method as defined in claim 2, wherein transmitting data from the mobile data station comprises transmitting packet-switched data from the mobile data station.

5. A method as defined in claim 4, wherein transmitting packet-switched data from the mobile data station comprises transmitting data without using network resources in a circuit-switched mode.

6. A method as defined in claim 4, wherein transmitting packet-switched data from the mobile data station comprises transmitting data according to a General Packet Radio Service (GPRS) standard.

7. A method as defined in claim 1, further comprising transmitting station class data from at least one of the mobile data station and the mobile voice station, the station class data identifying Class A of a European Telecommunications Standard Institute (ETSI) Global System for Mobile Communication (GSM) specification.

8. A method as defined in claim 1, wherein transmitting a SIM request from the mobile data station to the mobile voice station comprises transmitting the SIM request from a personal computer to a wireless telephone.

9. A method as defined in claim 1, wherein transmitting a SIM request from the mobile data station to the mobile voice station comprises transmitting the SIM request from a personal computer to a wireless telephone via a Bluetooth connection.

10. A virtual Subscriber Identity Module (SIM) card for a computing device, the virtual SIM card comprising:
a Bluetooth communication device; and
a remote SIM card client operatively coupled to the Bluetooth communication device, the remote SIM card client being structured to cause the Bluetooth communication device to transmit a SIM request to a mobile voice station which contains an actual SIM card, the remote SIM card client being structured to receive a SIM code via the Bluetooth communication device from the mobile voice station in response to transmitting the SIM request to the mobile voice station.

11. A virtual SIM card as defined in claim 10, wherein the remote SIM card client comprises:
a processor; and
a memory device coupled to the processor, the memory device storing a software program capable of being executed by the processor, the software program being structured to cause the processor to cause the Bluetooth communication device to transmit the SIM request to the mobile voice station.

12. A virtual SIM card as defined in claim 10, further comprising a Global System for Mobile Communication (GSM) transmitter, wherein the remote SIM card client is further structured to cause the GSM transmitter to transmit data from the computing device under the authority of the SIM code.

13. A virtual SIM card as defined in claim 10, further comprising a Global System for Mobile Communication (GSM) transmitter, wherein the remote SIM card client is further structured to cause the GSM transmitter to transmit packet-switched data from the computing device under the authority of the SIM code, the packet-switched data conforming to a General Packet Radio Service (GPRS) standard.

14. A virtual SIM card as defined in claim 10, further comprising a Global System for Mobile Communication (GSM) transmitter, wherein the remote SIM card client is further structured to cause the GSM transmitter to transmit class data identifying Class A of the European Telecommunications Standard Institute GSM standard.

15. An apparatus for providing simultaneous independent voice and data services using a shared Subscriber Identity Module (SIM) card, the apparatus comprising:
a circuit-switched voice station including a first wireless transceiver structured to provide circuit-switched voice services and a second transceiver structured to provide a short-range data service;
an actual SIM card coupled to the circuit-switched voice station;
a packet-switched data station physically separated from the circuit-switched voice station, the packet-switched data station including a third wireless transceiver structured to provide packet-switched data services and a fourth transceiver structured to provide the short-range data service;
a virtual SIM card module operatively coupled to the packet-switched data station, the virtual SIM card module being structured to request a SIM code from the actual SIM card via a communication signal between the second transceiver and the fourth transceiver.

16. An apparatus as defined in claim 15, wherein the apparatus is further structured to:
transmit voice information via the first wireless transceiver under the authority of the SIM code; and
transmit data via the third wireless transceiver under the authority of the SIM code, the data transmitted via the third wireless transceiver being transmitted simultaneous with the voice information being transmitted via the first wireless transceiver.

17. An apparatus as defined in claim 15, wherein the apparatus is further structured to:
transmit Universal Mobile Telecommunications System (UMTS) compatible voice information via the first wireless transceiver; and
transmit General Packet Radio Service (GPRS) compatible data via the third wireless transceiver, the data transmitted via the third wireless transceiver being transmitted simultaneous with the voice information being transmitted via the first wireless transceiver.

18. An apparatus as defined in claim 15, wherein the circuit-switched voice station comprises a Global System for Mobile Communication (GSM) compatible telephone and the packet-switched data station comprises a personal computer.

19. An apparatus as defined in claim 15, wherein the second transceiver comprises a first Bluetooth transceiver and the fourth transceiver comprises a second Bluetooth transceiver.

20. An apparatus as defined in claim 19, wherein the first transceiver comprises a Universal Mobile Telecommunications System (UMTS) transceiver and the third transceiver comprises a Global System for Mobile Communication (GSM) transceiver.
